(19) United States
(12) Patent Application Publication
(10) Pub. No.: US 2026/0148243 A1
(43) Pub. Date: May 28, 2026

(54) Method and System of Quantifying Carbon Footprint of a Power Supply

(71) Applicant: APPLETON GRP LLC, Rosemont, IL (US)

(72) Inventors: Earl Max Quisote Cambronero, Pasig (PH); Dan Kenneth Cesler Royo, Mandaluyong (PH); Roderick Perez De Castro, Batangas (PH)

(21) Appl. No.: 18/958,393

(22) Filed: Nov. 25, 2024

(51) Int. Cl. G06Q 30/018; H04L 12/10

(52) U.S. Cl. CPC G06Q 30/018; H04L 12/10

(57) ABSTRACT

A communication module includes one or more processors, and a computer readable medium storing instructions that, when executed by the one or more processors, cause the communication module to perform functions. The functions include receiving, from a power supply, first data indicating an amount of energy provided to a load by the power supply. The functions also include determining a carbon footprint based on the amount of the energy and an emission factor, and sending second data representing the carbon footprint to the power supply or a computing device.

### FIELD

The present disclosure relates generally to determining a carbon footprint based on an amount of energy provided to a load by a power supply, and more specifically to determining the carbon footprint based on an emission factor and the amount of energy provided to the load by the power supply.

### BACKGROUND

In manufacturing or industrial settings, communication modules are often used to provide an industrial power supply with connectivity to the internet and to other devices, such as a programmable logic controller (PLC). For example, the PLC can perform various actions or control other devices based on values of the diagnostic information (e.g, temperature, voltage, or current) that is related to the power supply and provided by the communication module. As industrial plants and factories become more data-driven, and power supplies and related components evolve to include more computing power, more useful applications for data generated by the power supplies and related components are discovered.

### SUMMARY

A first example is a communication module that includes one or more processors and a computer readable medium storing instructions that, when executed by the one or more processors, cause the communication module to perform functions that include receiving, from a power supply, first data indicating an amount of energy provided to a load by the power supply, determining a carbon footprint based on the amount of the energy and an emission factor, and sending second data representing the carbon footprint to the power supply or a computing device.

A second example is a method performed by a communication module. The method includes receiving, from a power supply, first data indicating an amount of energy provided to a load by the power supply, determining a carbon footprint based on the amount of the energy and an emission factor, and sending second data representing the carbon footprint to the power supply or a computing device.

A third example is a non-transitory computer readable medium storing instructions that, when executed by one or more processors of a communication module, cause the communication module to perform functions that include receiving, from a power supply, first data indicating an amount of energy provided to a load by the power supply, determining a carbon footprint based on the amount of the energy and an emission factor, and sending second data representing the carbon footprint to the power supply or a computing device.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The features, functions, and advantages that have been discussed can be achieved independently in various examples or may be combined in yet other examples further details of which can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a block diagram of three devices, according to an example.

FIG. 2 is a schematic diagram of operations of three devices, according to an example.

FIG. 3 is a schematic diagram of a device, according to an example.

FIG. 4 is a block diagram of a method, according to an example.

### DETAILED DESCRIPTION

A need exists for methods and systems that generate and display information related to a carbon footprint of a power supply or a collection of power supplies. This need may exist because of legal obligations to limit the carbon footprint or because of a private company's desire to reduce carbon emissions.

Accordingly, this disclosure includes devices and methods that help address this problem. For example, a communication module receives, from a power supply, first data indicating an amount of energy (e.g., in joules) provided to a load by the power supply. The energy could be provided to the load by the power supply during various periods of time, such as hours, days, weeks, etc. The communication module then determines a carbon footprint (e.g., in kilograms of carbon) based on the amount of the energy and an emission factor (e.g., in kilograms of carbon per joule). More particularly, the communication module can determine the carbon footprint by multiplying the amount of energy by the emission factor. The communication module can calculate carbon footprints that pertain to intervals of time such as hours, days, weeks, etc, or can calculate a running total carbon footprint. The emission factor can be based on known characteristics of the carbon footprint of energy generated in particular geographic regions. In other examples, the emission factor is selected based on how energy is generated locally at a factory or industrial plant. Next, the communication module sends second data representing the carbon footprint to the power supply or a computing device. The second data can be stored at the power supply and/or the computing device can display the data so that a carbon footprint can be displayed graphically with respect to time to identify trends.

Disclosed examples will now be described more fully hereinafter with reference to the accompanying Drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

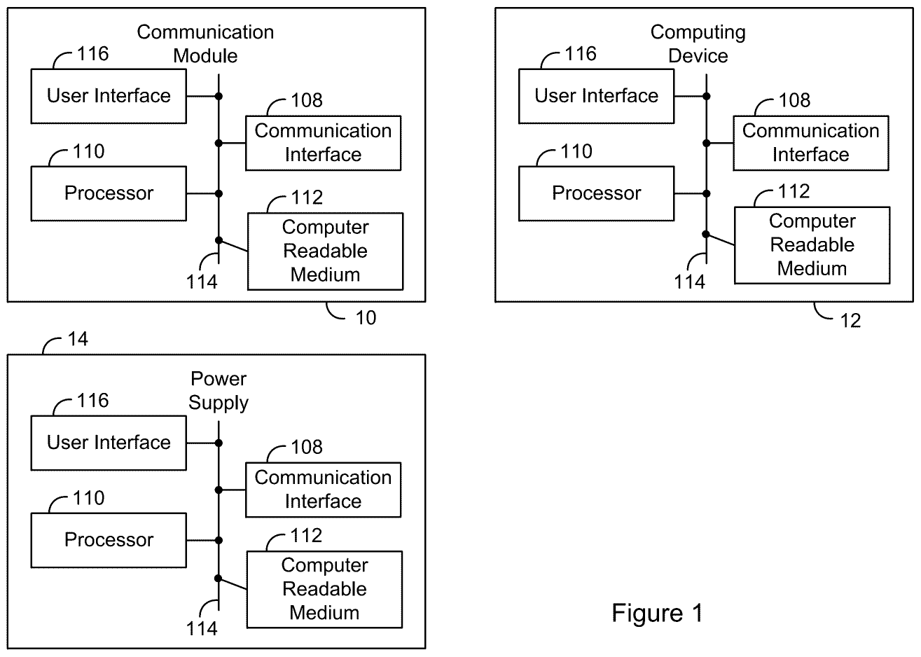

FIG. 1 is a block diagram of a communication module 10, a computing device 12, and a power supply 14, with which aspects of the present disclosure can be implemented. Each of the communication module 10, the computing device 12, and the power supply 14 includes a communication interface 108, one or more processors 110, a computer readable medium 112, and a user interface 116. The user interface 116, the communication interface 108, the processor 110, and the computer readable medium 112 can be linked with each other via a system bus, network, or other connection mechanism 114.

The communication interface 108 may take a variety of forms and is configured to allow the communication module 10, the computing device 12, and the power supply 14 to communicate with one or more other devices according to any number of protocols. In some examples, the communication interface 108 may take the form of a wired interface, such as an Ethernet interface. Additionally or alternatively, the communication interface 108 may take the form of a wireless interface, such as a cellular interface, a Bluetooth interface, or a Wi-Fi interface.

The processor 110 may include a general purpose processor (e.g., a microprocessor or a microcontroller) and/or a special purpose processor (e.g., a digital signal processor (DSP)).

The computer readable medium 112 may include one or more volatile, non-volatile, removable, and/or non-removable storage components, such as magnetic, optical, or flash storage, and may be integrated in whole or in part with the processor 110. Further, the computer readable medium 112 may have stored thereon program instructions (e.g., compiled or non-compiled program logic and/or machine code) that, when executed by the processor 110, cause the communication module 10, the computing device 12, or the power supply 14 to perform one or more functions, such as those described in this disclosure. In some examples, the computer readable medium 112 includes an electrically erasable programmable read-only memory (EEPROM), a non-volatile memory, and a random access memory (RAM).

The user interface 116 is configured for facilitating interaction between each of the communication module 10, the computing device 12, and the power supply 14, and a user, such as by receiving input from the user and providing output to the user. Thus, the user interface 116 may include input components such as a keyboard, a touchscreen, or push buttons. In addition, the user interface 116 may include output components such as a display screen, a sound speaker, or other audio output mechanism.

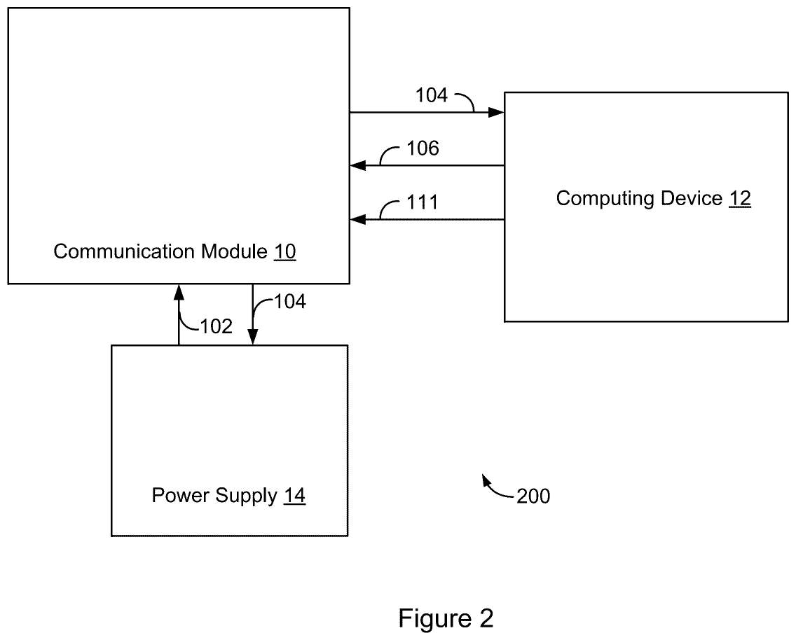

FIG. 2 is a schematic diagram of operations of the communication module 10, the computing device 12, and the power supply 14. The communication module 10 generally takes the form of an ethernet adapter configured to provide network connectivity for the power supply 14 via (1) a serial connection between the communication module 10 and the power supply 14 and (2) a network connection between the communication module 10 and one or more other servers or devices including the computing device 12. For example, the communication module 10 takes the form of a Sola HD SCM-E-EIP. In some examples, the communication module 10 is an ethernet adapter that is fully integrated with the power supply 14.

The computing device 12 can take the form of a desktop computer, a tablet computer, a smartphone, a programmable logic controller (PLC), and/or a human machine interface (HMI). Other examples are possible.

The power supply 14 can take the form of an industrial power supply or a UPS system. For instance, the power supply 14 can take the form of a SolaHD SDN10 24 100D, SDN20 24 100D, or SDN40 24 100D power supply or a SolaHD uninterruptible power supply system SDU10 24B or SDU20 24B.

In operation, the communication module 10 receives, from the power supply 14, data 102 indicating an amount of energy provided to a load by the power supply 14. The load can take the form of PLCs, industrial personal computers, gateways, input/output modules, motors, lighting devices, sensors, or pneumatic compressors, for example. For instance, the data 102 includes a numeric value E corresponding to the amount of energy (e.g., in joules) provided to a load during a time period of interest (e.g., minutes, hours, days, etc.). In other examples, the data 102 includes current and/or voltage values that can be used to derive the amount of energy E. Thus, the data 102 can explicitly or implicitly indicate the amount of energy E.

Next, the communication module 10 determines a carbon footprint CF (e.g., in kilograms of carbon) based on the amount of the energy E and an emission factor EF (e.g., in kilograms of carbon per joule). For example, the communication module 10 determines the amount of energy E as a product of i) a voltage V provided to the load by the power supply 14, (ii) a current I provided to the load by the power supply 14, and (iii) a duration T during which the power supply 14 provided the voltage V and the current I to the load. The power supply 14 can include a voltmeter and an ammeter that detects the voltage V and the current I, respectively. For example, the power supply 14 includes voltage and current sensors coupled to the processor 110 that detects the voltage V and the current I values, respectively.

Typically, the power supply 14 provides voltages and currents to a load that vary somewhat over time. These variations affect the actual carbon footprint CF of the power supply 14. Accordingly, the power supply 14 will periodically provide, to the communication module 10, the values of the instantaneous voltage and the instantaneous current provided to the load by the power supply 14. For example, the power supply 14 provides, to the communication module 10, an instantaneous voltage V₁ and an instantaneous current I₁ provided to the load at time t₁, an instantaneous voltage V₂ and an instantaneous current I₂ provided to the load at time t₂, an instantaneous voltage V₃ and an instantaneous current I₃ provided to the load at time t₃, and so on.

The communication module 10 can use these values to calculate an average voltage provided by the power supply 14 to the load and an average current provided by the power supply 14 to the load. For example, the average voltage V can be generated according to

$$\overline{V} = \frac{{\sum }_{i = 1}^{n} {V}_{i}}{i}$$

where n is the number of instantaneous voltages provided to the communication module 10 by the power supply 14. The average current I can be generated according to

$$\overline{I} = \frac{{\sum }_{i = 1}^{n} {I}_{i}}{n}$$

where n is the number of instantaneous currents provided to the communication module 10 by the power supply 14. Accordingly, the average energy E can be generated by the communication module 10 according to E=(V̅I̅) T where T is the duration of time during which the average voltage V̅ and the average current Ī were provided by the power supply 14 to the load. The carbon footprint CF can be generated by the communication module 10 according to CF=Ē×EF where EF is the emission factor EF.

After the communication module 10 determines the carbon footprint CF, the communication module 10 sends data 104 representing the carbon footprint CF to the power supply 14 and/or the computing device 12 so that the power supply 14 and/or the computing device 12 can process and/or store the data 104. In some examples, the communication module 10 stores the data 104 on the computer readable medium 112 of the communication module 10. More specifically, the communication module 10 stores the data 104 on a non-volatile component of the computer readable medium 112 of the communication module 10. In some examples, the communication module 10 provides the data 104 to the computing device 12 for display by the computing device 12, via a webserver interface provided by the communication module 10.

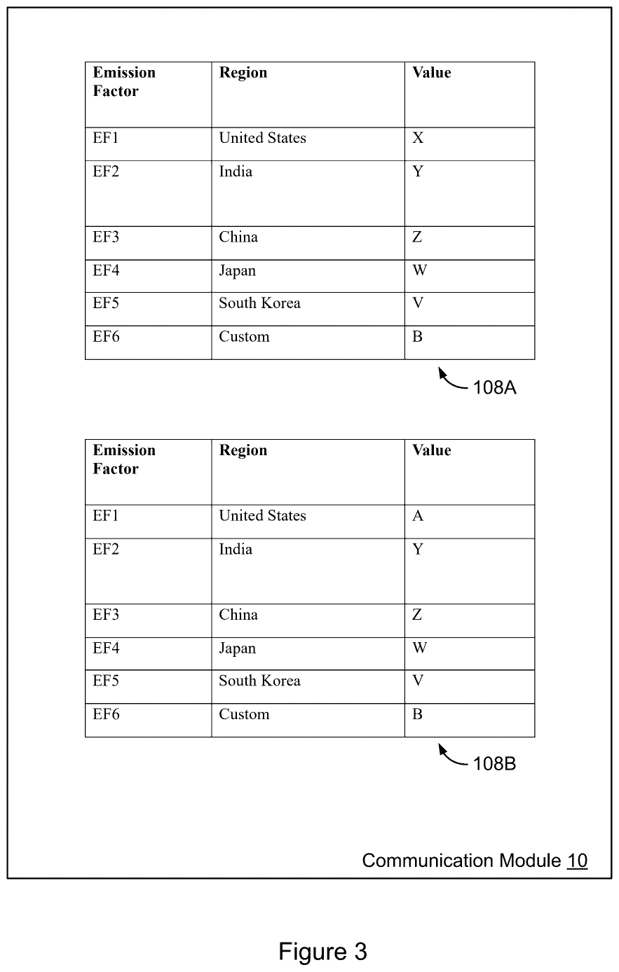

FIG. 3 is a schematic diagram of the communication module 10. Typically, the computer readable medium 112 of the communication module 10 stores several emission factors corresponding to different geographical regions. Additionally, the communication module 10 can store one or more custom emission factors that correspond to how energy is generated locally at a factory or industrial plant.

For example, the communication module 10 might initially store data 108A in the form of a data table. The data 108A associates an emission factor EF1 with the geographic region of the United States and a value of X (e.g., ‘X’ kg of carbon per joule). The data 108A associates an emission factor EF2 with the geographic region of India and a value of Y. The data 108A associates an emission factor EF3 with the geographic region of China and a value of Z. The data 108A associates an emission factor EF4 with the geographic region of Japan and a value of W. Lastly, the data 108A associates an emission factor EF5 with the geographic region of South Korea and a value of V. In some examples, the geographic regions are more local in nature than nations (e.g., counties, states, provinces, etc.) In some examples, the data 108A is stored in a non-volatile component of the computer readable medium 112 of the communication module 10.

Referring also to FIG. 2 by way of example, the communication module 10 receives a selection 106 of the United States geographic region from the computing device 12 via a webserver interface provided by the communication module 10. Accordingly, the active emission factor becomes EF1 having a value of X. The communication module 10 can then determine the carbon footprint CF by multiplying (1) the energy E provided to the load by the power supply 14 by (2) the emission factor EF1 having the value X.

In other examples, the webserver interface provided by the communication module 10 on the computing device 12 can be used to edit existing emission factors or to add new emission factors. For example, the communication module 10 receives, from the computing device 12 via the webserver interface, a command 111 to change the emission factor EF1 to a new value A. As a result, the communication module stores the data 108B in the form of a data table that associates the United States with the emission factor EF1 having the new value of A. The communication module 10 can write the new value of the emission factor EF1 to a non-volatile component of the computer readable medium 112 of the communication module 10. In this context, the communication module 10 can determine the carbon footprint CF by multiplying (1) the energy E provided to the load by the power supply 14 by (2) the emission factor EF1 having the value A.

In another example, the communication module 10 receives, from the computing device 12 via the webserver interface provided by the communication module 10, a selection 106 of a custom emission factor EF6 having a value of B. In this context, the communication module 10 can determine the carbon footprint CF by multiplying (1) the energy E provided to the load by the power supply 14 by (2) the emission factor EF6 having the value B. The communication module 10 can write the value of EF6 to a non-volatile component of the computer readable medium 112 of the communication module 10.

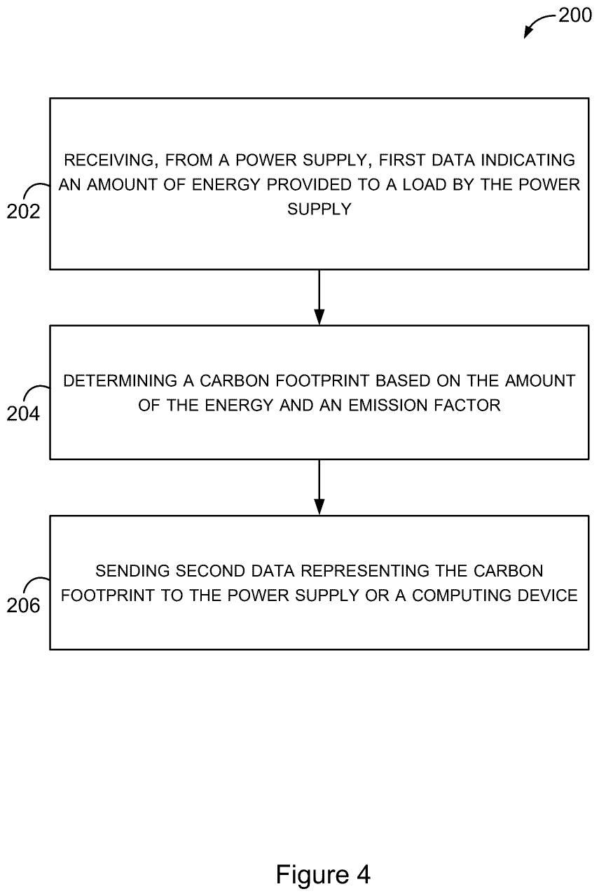

FIG. 4 is a block diagram of a method 200, which in some examples are performed by the communication module 10. As shown in FIG. 4, the method 200 includes one or more operations, functions, or actions as illustrated by blocks 202, 204, and 206. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes the communication module 10 receiving, from the power supply 14, the data 102 indicating the amount of energy E provided to a load by the power supply 14. Functionality related to block 202 is described above with reference to FIGS. 2 and 3.

At block 204, the method 200 includes the communication module 10 determining the carbon footprint CF based on the amount of the energy E and the emission factor EF. Functionality related to block 204 is described above with reference to FIGS. 2 and 3.

At block 206, the method 200 includes the communication module 10 sending the data 104 representing the carbon footprint CF to the power supply 14 or the computing device 12. Functionality related to block 206 is described above with reference to FIGS. 2 and 3.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A communication module comprising:
one or more processors; and
a computer readable medium storing instructions that, when executed by the one or more processors, cause the communication module to perform functions comprising:
receiving, from a power supply, first data indicating an amount of energy provided to a load by the power supply;
determining a carbon footprint based on the amount of the energy and an emission factor; and
sending second data representing the carbon footprint to the power supply or a computing device.

2. The communication module of claim 1, wherein the communication module is configured to serve as an ethernet adapter that provides network connectivity for the power supply.

3. The communication module of claim 1, wherein the computing device comprises a desktop computer, a tablet computer, a smartphone, or a programmable logic controller.

4. The communication module of claim 1, the functions further comprising:
receiving a selection of a geographic region via a webserver interface provided by the communication module,
wherein determining the carbon footprint comprises determining the carbon footprint based on the emission factor that corresponds to the geographic region.

5. The communication module of claim 4, wherein the emission factor is a first emission factor and the geographic region is a first geographic region, wherein the computer readable medium stores third data that associates (i) the first emission factor with the first geographic region and (ii) second emission factors with second geographic regions, respectively.

6. The communication module of claim 5, wherein the third data is stored on a non-volatile component of the computer readable medium.

7. The communication module of claim 5, the functions further comprising:
receiving, via the webserver interface, a command to change the first emission factor associated with the first geographic region to a new value; and
writing the new value of the first emission factor to a non-volatile component of the computer readable medium.

8. The communication module of claim 1, wherein the emission factor is a custom emission factor associated with how energy is generated for use by the power supply, the functions further comprising:
receiving, via a webserver interface provided by the communication module, a selection of the custom emission factor,
wherein determining the carbon footprint comprises determining the carbon footprint using the amount of energy and the custom emission factor.

9. The communication module of claim 8, the functions further comprising writing the custom emission factor to a non-volatile component of the computer readable medium.

10. The communication module of claim 1, wherein determining the carbon footprint comprises determining the carbon footprint as a product of the amount of the energy multiplied by the emission factor.

11. The communication module of claim 10, the functions further comprising determining the amount of the energy as a second product of (i) a voltage provided to the load by the power supply, (ii) a current provided to the load by the power supply, and (iii) a duration during which the power supply provided the voltage and the current to the load.

12. The communication module of claim 11, wherein the voltage is an average voltage and the current is an average current, the functions further comprising:
determining the average voltage by averaging instantaneous voltage values received from the power supply during the duration; and
determining the average current by averaging instantaneous current values received from the power supply during the duration.

13. The communication module of claim 1, the functions further comprising storing the second data on the computer readable medium.

14. The communication module of claim 1, wherein sending the second data to the computing device comprises providing the second data for display via a webserver interface provided by the communication module.

15. A method performed by a communication module, the method comprising:
receiving, from a power supply, first data indicating an amount of energy provided to a load by the power supply;
determining a carbon footprint based on the amount of the energy and an emission factor; and
sending second data representing the carbon footprint to the power supply or a computing device.

16. The method of claim 15, further comprising:
receiving a selection of a geographic region via a webserver interface provided by the communication module,
wherein determining the carbon footprint comprises determining the carbon footprint based on the emission factor that corresponds to the geographic region.

17. The method of claim 16, wherein the emission factor is a first emission factor and the geographic region is a first geographic region, wherein a computer readable medium of the communication module stores third data that associates (i) the first emission factor with the first geographic region and (ii) second emission factors with second geographic regions, respectively.

18. The method of claim 17, further comprising:
receiving, via the webserver interface, a command to change the first emission factor associated with the first geographic region to a new value; and
writing the new value of the first emission factor to a non-volatile component of the computer readable medium.

19. The method of claim 15, wherein determining the carbon footprint comprises determining the carbon footprint as a product of the amount of the energy multiplied by the emission factor, the method further comprising determining the amount of the energy as a second product of (i) a voltage provided to the load by the power supply, (ii) a current provided to the load by the power supply, and (iii) a duration during which the power supply provided the voltage and the current to the load.

20. A non-transitory computer readable medium storing instructions that, when executed by one or more processors of a communication module, cause the communication module to perform functions comprising:
receiving, from a power supply, first data indicating an amount of energy provided to a load by the power supply;
determining a carbon footprint based on the amount of the energy and an emission factor; and
sending second data representing the carbon footprint to the power supply or a computing device.
